(19) United States
(12) Patent Application Publication
(10) Pub. No.: US 2014/0132397 A1
(43) Pub. Date: May 15, 2014

(54) METHOD OF DECODING RESPONSE SIGNAL FROM RADIO FREQUENCY IDENTIFICATION

(71) Applicant: Electronics and Telecommunications Research Institute, (US)

(72) Inventor: Hyuk Je KWON, Seoul (KR)

(73) Assignee: Electronics and Telecommunications Research Institute, Daejeon (KR)

(21) Appl. No.: 13/869,583

(22) Filed: Apr. 24, 2013

(30) Foreign Application Priority Data
Nov. 14, 2012 (KR) 10-2012-0128827

(51) Int. Cl. G06K 7/10

(52) U.S. Cl. CPC G06K 7/10009
USPC 340/10.4

(57) ABSTRACT

A data decoder may include a subcarrier removing unit configured to remove a subcarrier from first data to generate second data, a preamble detecting unit configured to detect a preamble for the second data, and a decoding unit configured to decode the second data based on the detected preamble.

### CROSS-REFERENCE TO RELATED APPLICATION

This application claims the priority benefit of Korean Patent Application No. 10-2012-0128827, filed on Nov. 14, 2012, in the Korean Intellectual Property Office, the disclosure of which is incorporated herein by reference.

### BACKGROUND

1. Field

Example embodiments of the following description relate to a radio frequency identification (RFID) technology, and more particularly, to an RFID reader for decoding data having undergone the Miller subcarrier removal and preamble detection, and a method of removing a subcarrier, detecting a preamble, and decoding data.

2. Description of the Related Art

Radio frequency identification (RFID) technology is a technology using radio-frequency electromagnetic fields to transfer data from a tag attached to an object for the purpose of automatic identification and tracking. The RFID technology has a wide range of applications in the industrial field. For example, an RFID tag attached to an automobile may be used for a toll system and a car parking system, or an RFID garment tag may be used to identify information associated with clothing.

Generally, the RFID technology uses to an RFID tag attached to an object and an RFID reader to recognize the object. The RFID reader may be also called an interrogator.

The RFID reader transmits a transmitting signal to the RFID tag and receives a response signal from the RFID tag. The response signal from the RFID tag includes a preamble and data, such as, for example, a unique number of the tag, information on the object, a production date of the object, and other detailed information.

The preamble is used to recognize a starting point of the data. Accordingly, the RFID reader proper detection of the preamble is required for recognition of the data from the RFID tag response signal.

### SUMMARY

The foregoing and/or other aspects are achieved by providing a data decoder including a subcarrier removing unit configured to remove a subcarrier from first data to generate second data, a preamble detecting unit configured to detect a preamble for the second data, and a decoding unit configured to decode the second data based on the detected preamble.

The subcarrier removing unit may be configured to generate a first signal corresponding to the subcarrier, and to perform an exclusive-OR operation on the first signal and the first data to generate a second signal.

The subcarrier removing unit may be configured to remove noise from the second signal by executing synchronization on the second signal using a synchronous clock, to generate a third signal.

The subcarrier removing unit may be configured to conduct a count for the third signal based on an enable signal generated in association with Miller demodulation.

The enable signal may be used to execute synchronization based on an edge of the first data.

The subcarrier removing unit may further include a comparator configured to compare a first count signal to a second count signal during each bit period, the first count signal may be used to detect a high value of the third signal for a duration in which a value of the enable signal is ‘0’, and the second count signal may be used to detect a high value of the third signal for a duration in which a value of the enable signal is ‘1’.

The comparator may be configured to generate a decoding bit for a difference between the first count signal and the second count signal based on a predetermined threshold value.

The preamble detecting unit may include a sampling signal generating unit configured to generate a sampling signal for the second data.

The preamble detecting unit may be configured to set at least four phases of the second data based on the sampling signal.

The preamble detecting unit may be configured to count a number of sampling signals generated for each of the at least four phases, and to determine an end point of a final preamble when the number of sampling signals generated satisfies a predetermined condition for each phase.

The foregoing and/or other aspects are also achieved by providing a method of decoding data, the method including removing a subcarrier from first data through a comparison operation being performed on the first data and a first signal corresponding to the subcarrier, to generate second data, removing noise from the second signal to generate a third signal, detecting a preamble for the third signal, and decoding the third signal based on the detected preamble.

The removing of the noise from the second signal to generate the third signal may further include conducting a count for the third signal based on an enable signal generated in association with Miller demodulation, comparing a first count signal to a second count signal during each bit period, the first count signal being used to detect a high value of the third signal for a duration in which a value of the enable signal is ‘0’, and the second count signal being used to detect a high value of the third signal for a duration in which a value of the enable signal is ‘1’, and generating a decoding bit for a difference between the first count signal and the second count signal based on a predetermined threshold value.

The enable signal may be used to execute synchronization based on an edge of the first data.

The detecting of the preamble for the third signal may include setting at least four phases of the third signal based on the sampling signal generated for the third signal, and counting a number of sampling signals generated for each of the at least four phases, and determining an end point of a final preamble when the number of sampling signals generated satisfies a predetermined condition for each phase.

Additional aspects of embodiments will be set forth in part in the description which follows and, in part, will be apparent from the description, or may be learned by practice of the disclosure.

### BRIEF DESCRIPTION OF THE DRAWINGS

These and/or other aspects will become apparent and more readily appreciated from the following description of embodiments, taken in conjunction with the accompanying drawings of which:

FIG. 1 illustrates an example of a data decoder;

FIG. 2 illustrates the data decoder of FIG. 1;

FIG. 3 illustrates an example of an exclusive OR (EXOR) operation being performed on a radio frequency identification (RFID) response signal and a subcarrier correlation signal;

FIG. 4 illustrates an example of subcarrier removal;

FIG. 5 illustrates another example of subcarrier removal;

FIG. 6 illustrates an example of phase characteristics analysis and preamble determination based on a sampling signal;

FIG. 7 is a flowchart illustrating a method of determining a preamble according to an example embodiment;

FIG. 8 illustrates an example of a detailed preamble determination; and

FIG. 9 is a flowchart illustrating a method of decoding data according to an example embodiment.

### DETAILED DESCRIPTION

Reference will now be made in detail to embodiments, examples of which are illustrated in the accompanying drawings, wherein like reference numerals refer to the like elements throughout. Embodiments are described below to explain the present disclosure by referring to the figures.

Particular terms may be defined to describe the invention in the best manner. Accordingly, the meaning of specific terms or words used in the specification and the claims should not be limited to a literal or commonly employed sense, but should be construed in accordance with the spirit of the invention.

Unless otherwise defined, all terms including technical and scientific terms used herein have the same meaning as commonly understood by one of ordinary skill in the art to which this invention belongs. It will be further understood that terms, such as those defined in commonly used dictionaries, should be interpreted as having a meaning consistent with the meaning in the context of the relevant art and will not be interpreted in an idealized or overly formal sense unless expressly defined herein.

Hereinafter, “first data” may refer to a response signal from a radio frequency identification (RFID) tag, and may include at least one of a unique number of a tag, information of an object, a production date of the object, and other information.

A “first signal” may refer to a signal corresponding to a subcarrier of the first data, and may be used to remove the subcarrier from the first data.

A “second signal” may refer to a signal generated by removing the subcarrier from the first signal.

A “third signal” may refer to a signal generated by removing noise from the second signal.

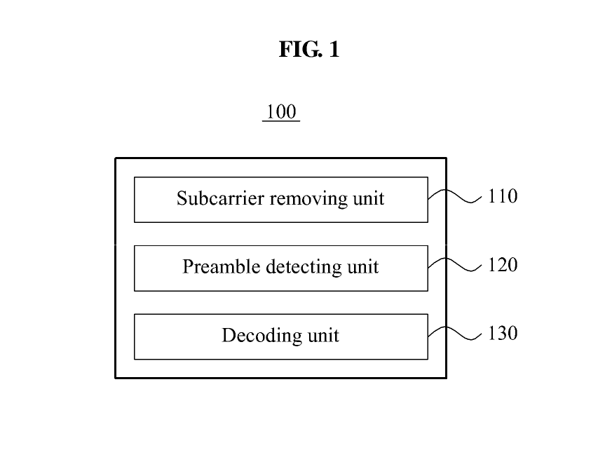

FIG. 1 illustrates an example of a data decoder 100.

Referring to FIG. 1, the data decoder 100 may include a subcarrier removing unit 110, a preamble detecting unit 120, and a decoding unit 130.

The subcarrier removing unit 110 may remove a subcarrier from an RFID tag response signal, namely, first data.

The subcarrier removing unit 110 may generate a first signal corresponding to the subcarrier, and may remove the subcarrier from the first data using the first signal. The subcarrier removing unit 110 may remove the subcarrier from the first data by performing an exclusive OR operation, symbolized by EXOR, on the first signal and the first data, to generate a second signal.

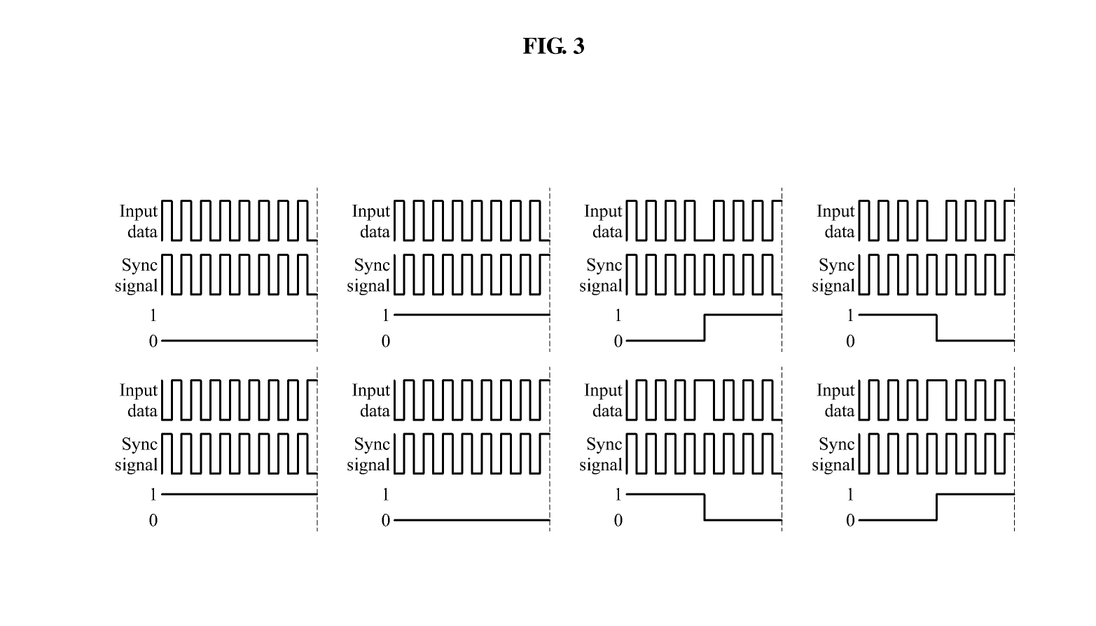

The EXOR operation being performed on the first signal and the first data is described in further detail with reference to FIG. 3.

The second signal generated by the EXOR operation may be buffered to remove noise. The subcarrier removing unit 110 may remove noise from the second signal to generate a third signal.

To remove noise from the second signal, the subcarrier removing unit 110 may execute synchronization on the second signal using a synchronous clock.

The synchronous clock may refer to a signal having a phase slower than that of the first signal, and may be used to remove noise, for example, glitch, that may occur while an EXOR operation is being performed.

The subcarrier removing unit 110 may generate an enable signal associated with Miller demodulation, and may conduct a count for the third signal using the enable signal.

The enable signal may be used for synchronization based on an edge of the first data.

The subcarrier removing unit 110 may include a comparator to compare a first count signal to a second count signal during each bit period. The first count signal may be used to detect a high value of the third signal for a duration in which a value of the enable signal is ‘0’, and the second count signal may be used to detect a high value of the third signal for a duration in which a value of the enable signal is ‘1’.

The comparator may generate a decoding bit based on a difference the first count signal and the second count signal with respect to a predetermined threshold value.

The comparator may compare the first count signal to the second count signal during each bit period, and may generate a decoding bit ‘1’ when a difference between the two signals is greater than the threshold value and may generate a decoding bit ‘0’ when a difference between the two signals is less than or equal to the threshold value.

The threshold value may correspond to an external input value, and may be used as a reference value for determining the decoding bit based on the difference between the first count signal and the second signal.

The decoding bit may be input with a least significant bit and may be moved to a most significant bit, and the comparator may assign a decoding bit ‘0’ or ‘1’ based on the difference the first count signal and the second count signal with respect to the threshold value.

According to another example embodiment, Miller demodulation may be performed by executing probing twice on the glitch-free synchronized signal, namely, the third signal.

The preamble detecting unit 120 may detect a preamble for second data generated by removing the subcarrier from the first data.

The preamble detecting unit 120 may conduct an analysis using a known pilot tone and a known preamble pattern, and may generate a reference signal for determining a final bit using signal characteristics generated during analysis.

According to an example embodiment, the second data may be understood as a third signal generated by removing a subcarrier and a noise component, for example, glitch, from the first data.

According to another example embodiment, the second data may be understood as a second signal generated by removing a subcarrier through an EXOR operation being performed on the first data and the first signal, but absent removing a noise component, for example, a glitch.

The preamble detecting unit 120 may further include a sampling signal generating unit to generate a sampling signal for the second data and to set at least four phases of the second data based on the sampling signal.

The sampling signal generating unit may generate two sampling signals per Miller bit. The sampling signals may be placed at a front part and a rear part for each bit. The sampling signals may be generated at a predetermined interval from an edge of a subcarrier digital demodulated signal, and the phases may be set based on a number of sampling signals generated at the same level as the subcarrier digital demodulated signal.

The preamble detecting unit 120 may count a number of sampling signals generated for each of the at least four phases, and when the number of sampling signals generated satisfies a predetermined condition for each phase, may determine an end point of a final preamble.

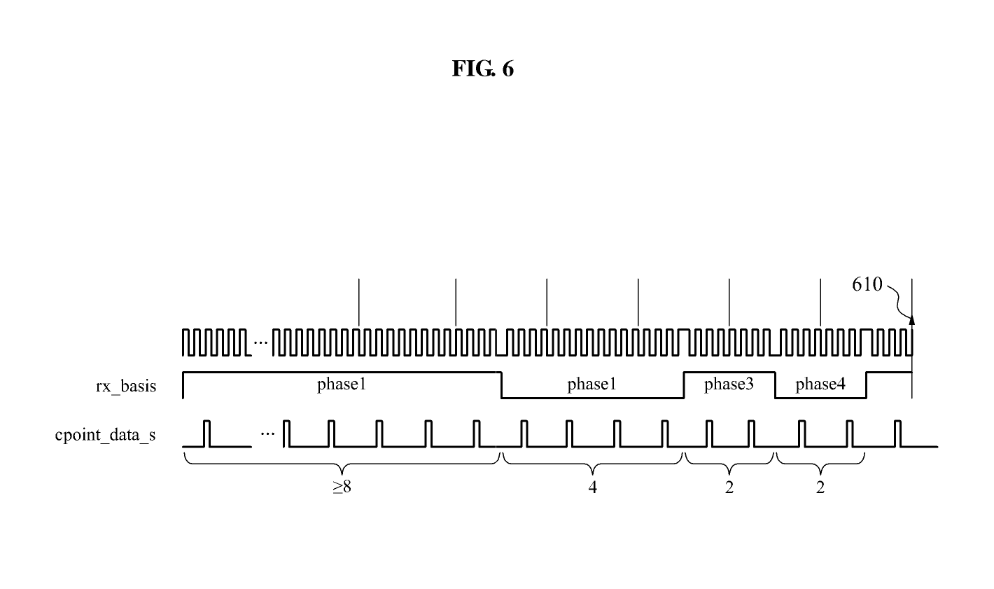

The phase characteristics analysis and preamble determination based on the sampling signal is described in further detailed with reference to FIG. 6.

The decoding unit 130 may decode the second data based on the detected preamble. The decoding unit 130 may decode the second data aside from the preamble.

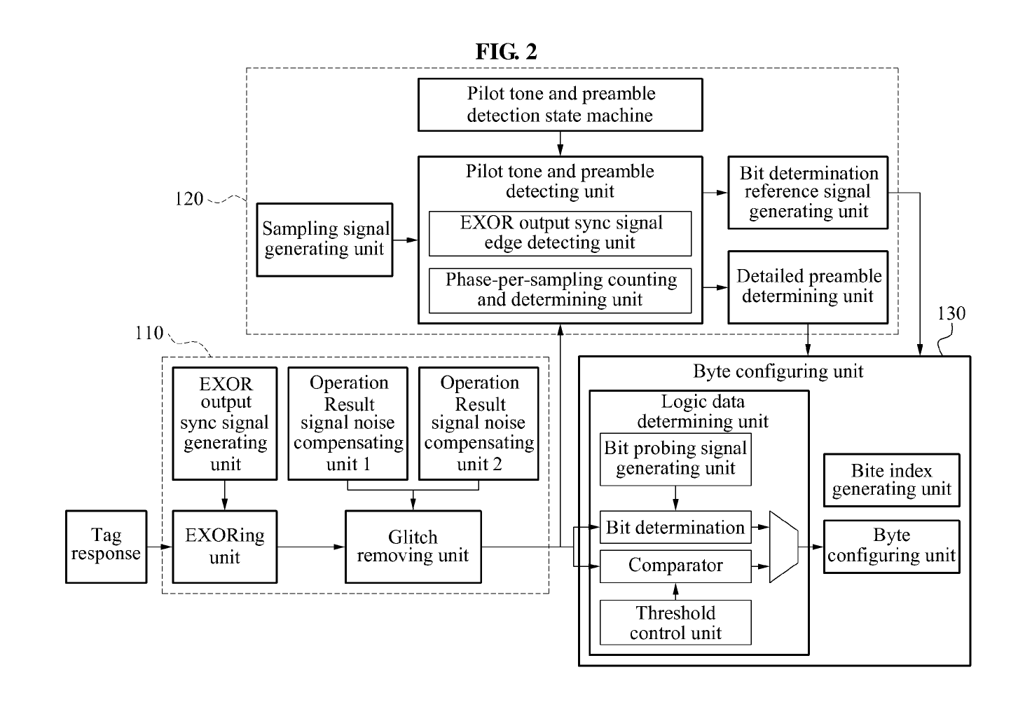

FIG. 2 illustrates the data decoder of FIG. 1.

The subcarrier removing unit 110 may remove a subcarrier produced by RFID load modulation from an RFID tag response signal. The subcarrier removing unit 110 may perform an EXOR operation on an RFID tag response signal, namely, first data, and a first signal corresponding to the subcarrier of the first data.

The subcarrier removing unit 110 may remove a glitch from an EXOR output signal, namely, a second signal.

The preamble detecting unit 120 may detect a pilot tone and a preamble before data of the RFID tag response signal to decode actual tag data. The preamble detecting unit 120 may conduct an analysis using a known pilot tone and a known preamble pattern, and may generate a reference signal for determining a final bit.

The preamble detecting unit 120 may generate a sampling signal for a third signal, and may set at least four phases of the third signal based on the sampling signal.

The preamble detecting unit 120 may count a number of sampling signals generated for each of the at least four phases, and when the number of sampling signals generated satisfies a predetermined condition for each phase, may determine an end point of a final preamble.

After the preamble detecting unit 120 completes a count of the number of sampling signals for each of the at least four phases, the preamble detecting unit 120 may perform a detailed preamble determination to generate a more correct preamble detection signal.

The decoding unit 130 may decode, into bytes, the data of the RFID tag response signal having undergone the subcarrier removal and the pilot tone/preamble detection.

The decoding unit 130 may represent, into bytes, a decoding bit generated based on the results produced by the subcarrier removing unit 110 and the preamble detecting unit 120.

FIG. 3 illustrates an example of an EXOR operation being performed on the first data and the first signal.

In FIG. 3, “input data” may refer to an RFID tag response signal, namely, first data, and a “sync signal” may refer to a first signal corresponding to a subcarrier of the first data.

A Miller signal may be characterized by data being determined based on whether a phase transition takes place in the middle of bit period. Using this characteristic of the Miller signal, the subcarrier removing unit 110 may perform an EXOR operation on the first data and the first signal having the same frequency and the same phase.

The EXOR operation may produce an output signal, namely, a second signal, and the output signal may be demodulated by comparing a count signal to a threshold value or comparing two probing signals during each bit period.

Also, the subcarrier removing unit 110 may determine a logic ‘1’ or a logic ‘0’ through the EXOR output signal, namely, the second signal. In this case, subcarrier removal may be simplified by eliminating counting of a number of 1-bits and only detecting a phase transition of the output signal.

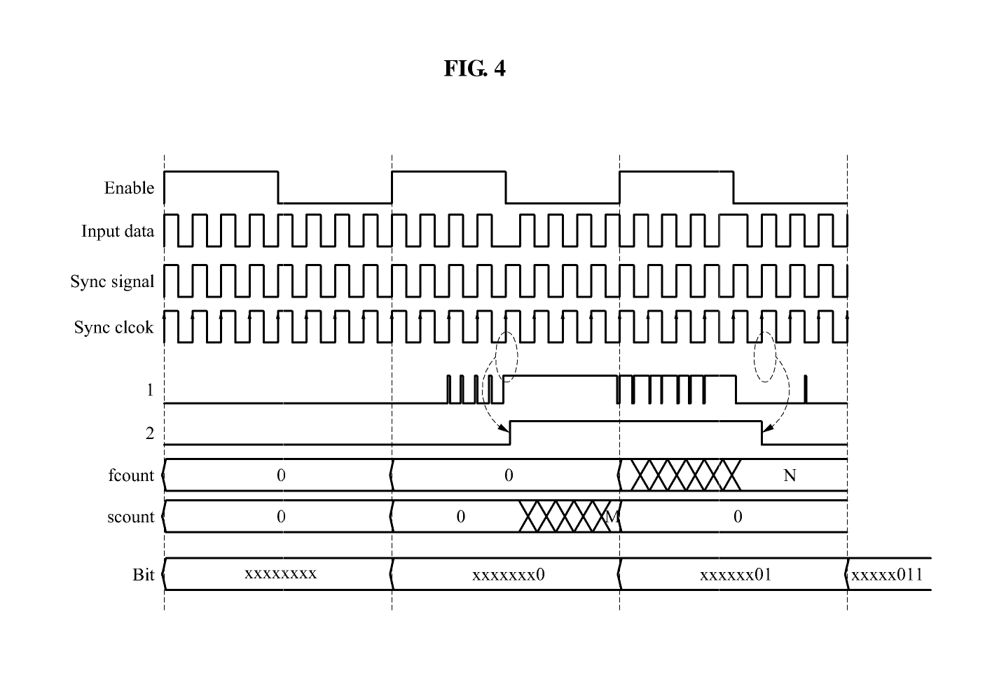

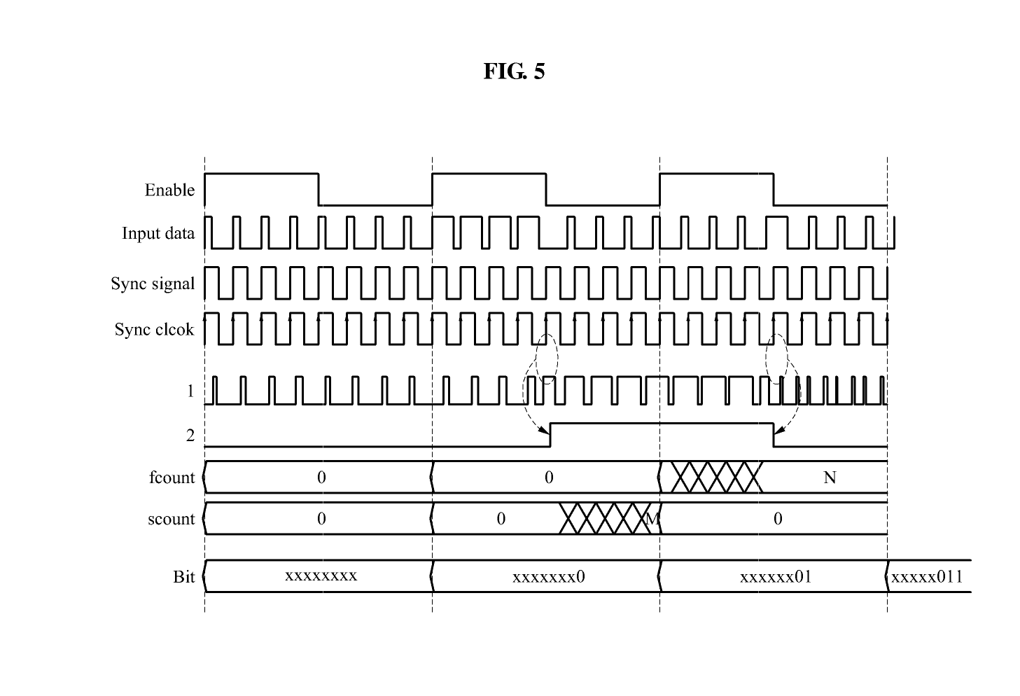

FIGS. 4 and 5 illustrate examples of subcarrier removal.

In FIGS. 4 and 5, “input data” may refer to an RFID tag response signal, namely, first data, a “sync signal” may refer to a first signal corresponding to a subcarrier of the first data, and a “waveform 1” may refer to an EXOR output signal of the first data and the first signal, namely, a second signal.

A “sync clock” may refer to a synchronous clock signal for buffering the second signal. The sync clock may be used for synchronization of the second signal to remove noise from the second signal. A “waveform 2” may refer to the noise-free signal, namely, a third signal.

For example, when the first data and the first signal have the same phase and the same frequency, the EXOR output signal of the first data and the first signal may be free of glitches. However, since the two signals correspond to a gating signal, synchronization or buffering using the sync clock may be performed to remove a glitch from the output signal.

“Enable” may refer to an enable signal generated in association with Miller demodulation. The enable signal may be used to conduct a count for the third signal, here, the waveform 2.

The enable signal may be used to execute synchronization based on an edge of the first data, here, the input data, and may be reset at the end of a bit period for a new bit.

“scount” may refer to a first count signal being used to detect a high value of the third signal for a duration in which a value of the enable signal is ‘0’, and “fcount” may refer to a second count signal being used to detect a high value of the third signal for a duration in which a value of the enable signal is ‘1’.

The first count signal “scount” and the second count signal “fcount” may be controlled by the enable signal. The number of counts included in the first count signal “scount” and the second count signal “fcount” may be reset with the start of a new bit.

As a result of comparing the first count signal “scount” to the second count signal “fcount” during each bit period, a decoding bit ‘1’ may be generated when a difference between the two signals is greater than a threshold value, and a decoding bit ‘0’ may be generated when a difference between the two signals is less than or equal to the threshold value.

The threshold value may correspond to an external input value, and may be used as a reference value for determining the decoding bit based on the difference between the first count signal and the second signal.

The decoding bit may be shown in the bit waveform of FIGS. 4 and 5.

FIG. 6 illustrates an example of phase characteristics analysis and preamble determination based on the sampling signal.

In FIG. 6, the basic characteristics of a subcarrier digital demodulated signal of a Miller signal are shown, and the subcarrier digital demodulated signal may be sampled using a sampling signal cpoint_data_s.

Two sampling signals may be generated per Miller bit. The sampling signals may be placed at a front part and a rear part for each bit. The sampling signals may be generated at a predetermined interval from an edge of a subcarrier digital demodulated signal, and each phase may be set based on a number of sampling signals generated at the same level as the subcarrier digital demodulated signal.

The preamble detecting unit 120 may count a number of sampling signals generated for each of the at least four phases, and when the number of sampling signals generated satisfies a predetermined condition for each phase, may determine an end point of a final preamble.

At least four phases may be set for the second data based on the sampling signal cpoint_data_s.

The number of sampling signals for each phase may be shown in Table 1.

TABLE 1

| Section | Number of sampling signals |
|---|---|
| Phase 1 | ≧8 |
| Phase 2 | 4 |
| Phase 3 | 2 |
| Phase 4 | 2 |

Referring to Table 1, it may be found that a number of sample signals in phase 1 is greater than or equal to 8 and a number of sample signals in the remaining phases is fixed to a predetermined value.

Since this feature is continuous, the pilot tone/preamble detection may be performed again from phase 1 when an error occurs in a certain phase.

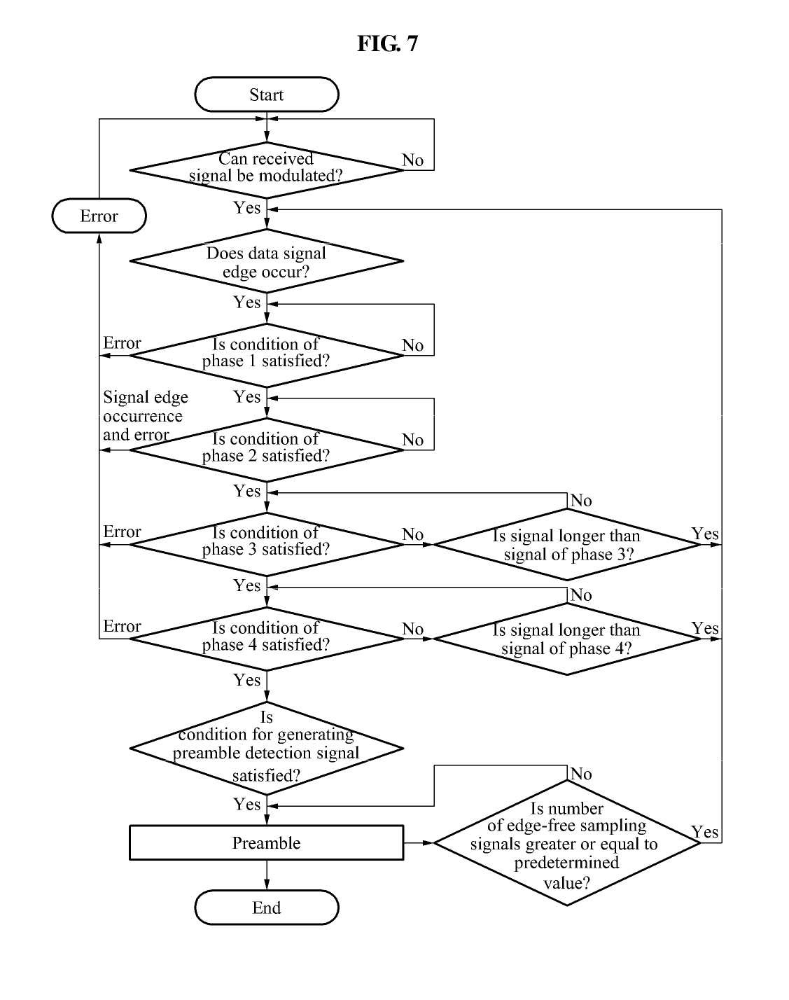

FIG. 7 is a flowchart illustrating a method of determining a preamble according to an example embodiment.

The preamble detecting unit 120 may count a number of sampling signals generated for each of the at least four phases of the second data, and determine whether the number of sampling signals generated satisfies a predetermined condition for each phase.

When the number of sampling signals generated is determined to satisfy the predetermined condition, the preamble detecting unit 120 may move to a next phase, and when the number of sampling signals generated fails to satisfy the predetermined condition, the preamble detecting unit 120 may determine the failure to be an error and may revert to phase 1.

When the second data satisfies the predetermined condition for each of the at least four phases, the preamble detecting unit 120 may determine a preamble based on the final result.

Since an error is likely to occur in the subcarrier digital demodulated signal even though a preamble is detected, error monitoring and new preamble detection may be performed in a continuous manner.

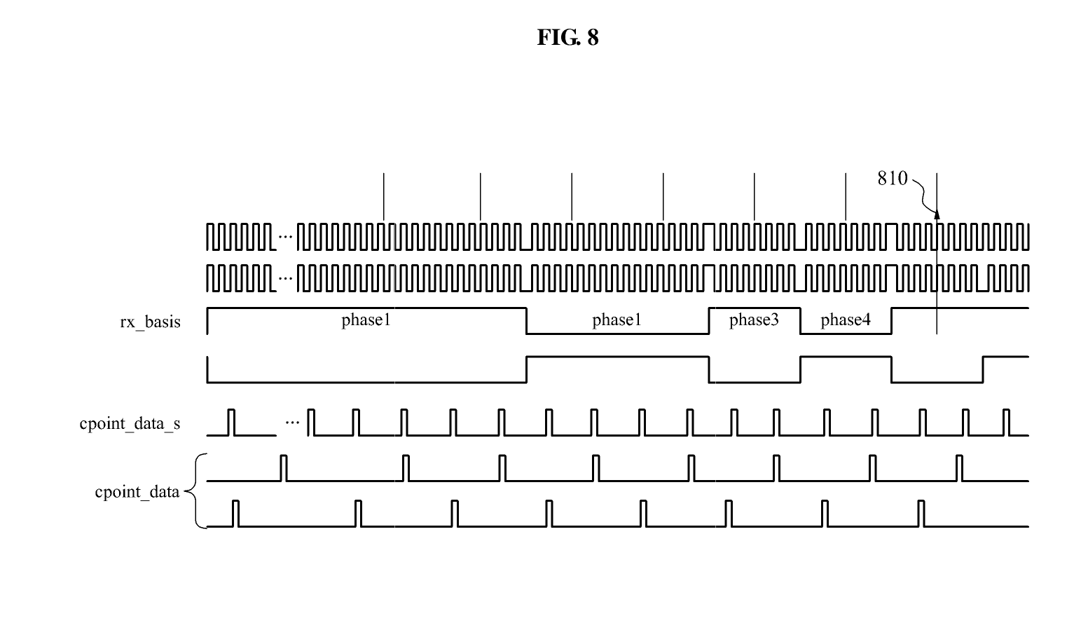

FIG. 8 illustrates an example of detailed preamble determination.

To generate a more correct preamble detection signal, the preamble detecting unit 120 may conduct a detailed preamble determination after completing the preamble determination.

For example, after the preamble detecting unit 120 determines whether the second data satisfies the predetermined condition throughout all phases, the preamble detecting unit 120 may determine an end point of a final preamble, in turn, a start point of data.

In FIG. 8, two phase patterns of a Miller subcarrier demodulated signal rx_basis are shown. Here, two phase-shifted patterns of the rx_basis are omitted.

Even though all the preambles of the second data are detected through detection of the final phase 4 of the second data, in FIG. 8, phase 4 of the rx_basis, an operation of determining a data start point of the second data may be performed.

The data start point indicated as reference numeral 810 of FIG. 8 may be determined based on a predetermined period of time from a first sampling signal cpoint_data_s generated after the end point of phase 4.

The predetermined period of time may be set to be a period of time from an edge signal of the Miller subcarrier demodulated signal serving as a reference signal for generating the sampling signal cpoint_data_s.

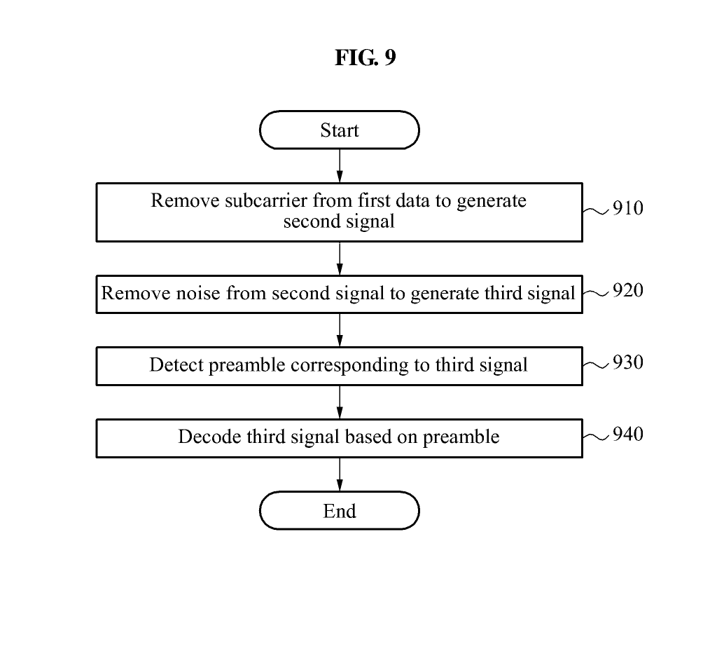

FIG. 9 is a flowchart illustrating a method of decoding data according to an example embodiment.

In operation 910, the subcarrier removing unit 110 may generate a first signal corresponding to a subcarrier of first data, and may remove the subcarrier from the first data using the first signal. The subcarrier removing unit 110 may remove the subcarrier from the first data by performing a comparison operation on the first signal and the first data, to generate a second signal.

In operation 920, the subcarrier removing unit 110 may remove noise from the second signal to generate a third signal.

To remove noise from the second signal, the subcarrier removing unit 110 may execute synchronization on the second signal using a synchronous clock.

The synchronous clock may refer to a signal having a phase slower than that of the first signal, and may be used to remove noise, for example, glitch, that may occur while an EXOR operation is being performed.

The subcarrier removing unit 110 may generate an enable signal associated with Miller demodulation, and may conduct a count for the third signal based on the enable signal.

The enable signal may be used for synchronization based on an edge of the first data.

The subcarrier removing unit 110 may compare a first count signal to a second count signal during each bit period, and may generate a decoding bit based on the difference the first count signal and the second count signal with respect to a predetermined threshold value. The first count signal may be used to detect a high value of the third signal for a duration in which a value of the enable signal is ‘0’, and the second count signal may be used to detect a high value of the third signal for a duration in which a value of the enable signal is ‘1’.

As a result of comparing the first count signal to the second count signal during each bit period, a decoding bit ‘1’ may be generated when a difference between the two signals is greater than the threshold value and a decoding bit ‘0’ may be generated when a difference between the two signals is less than or equal to the threshold value.

The threshold value may correspond to an external input value, and may be used as a reference value for determining the decoding bit based on the difference between the first count signal and the second signal.

According to another example embodiment, Miller demodulation may be performed by executing probing on the glitch-free synchronized signal twice, namely, the third signal.

In operation 930, the preamble detecting unit 120 may detect a preamble for the third signal.

The preamble detecting unit 120 may conduct an analysis using a known pilot tone and a known preamble pattern, and may generate a reference signal for determining a final bit using signal characteristics generated during analysis.

The preamble detecting unit 120 may generate a sampling signal for the third signal, and may set at least four phases of the third signal based on the sampling signal.

The sampling signal generating unit may generate two sampling signals per Miller bit. The sampling signals may be generated at a front part and a rear part for each bit. The sampling signals may be generated at a predetermined interval from an edge of a subcarrier digital demodulated signal, and the phases may be set based on a number of sampling signals generated at the same level as the subcarrier digital demodulated signal.

The preamble detecting unit 120 may count a number of sampling signals generated for each of the at least four phases, and when the number of sampling signals generated satisfies a predetermined condition for each phase, may determine an end point of a final preamble.

In operation 940, the decoding unit 130 may decode the third signal based on the detected preamble.

The units described herein may be implemented using hardware components, software components, or a combination thereof. For example, a processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums.

The computer readable recording medium may include any data storage device that can store data which can be thereafter read by a computer system or processing device. Examples of the computer readable recording medium include read-only memory (ROM), random-access memory (RAM), CD-ROMs, magnetic tapes, floppy disks, optical data storage devices. Also, functional programs, codes, and code segments for accomplishing the example embodiments disclosed herein can be easily construed by programmers skilled in the art to which the embodiments pertain based on and using the flow diagrams and block diagrams of the figures and their corresponding descriptions as provided herein.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A data decoder comprising:
a subcarrier removing unit configured to remove a subcarrier from first data to generate second data;
a preamble detecting unit configured to detect a preamble for the second data; and
a decoding unit configured to decode the second data based on the detected preamble.

2. The data decoder of claim 1, wherein the subcarrier removing unit is configured to generate a first signal corresponding to the subcarrier, and to perform an exclusive-OR operation on the first signal and the first data to generate a second signal.

3. The data decoder of claim 2, wherein the subcarrier removing unit is configured to remove noise from the second signal by executing synchronization on the second signal using a synchronous clock, to generate a third signal.

4. The data decoder of claim 3, wherein the subcarrier removing unit is configured to conduct a count for the third signal based on an enable signal generated in association with Miller demodulation.

5. The data decoder of claim 4, wherein the enable signal is used to execute synchronization based on an edge of the first data.

6. The data decoder of claim 4, wherein the subcarrier removing unit further comprises a comparator configured to compare a first count signal to a second count signal during each bit period, wherein the first count signal is used to detect a high value of the third signal for a duration in which a value of the enable signal is ‘0’, and the second count signal is used to detect a high value of the third signal for a duration in which a value of the enable signal is ‘1’.

7. The data decoder of claim 6, wherein the comparator is configured to generate a decoding bit for a difference between the first count signal and the second count signal based on a predetermined threshold value.

8. The data decoder of claim 1, wherein the preamble detecting unit comprises a sampling signal generating unit configured to generate a sampling signal for the second data.

9. The data decoder of claim 8, wherein the preamble detecting unit is configured to set at least four phases of the second data based on the sampling signal.

10. The data decoder of claim 9, wherein the preamble detecting unit is configured to count a number of sampling signals generated for each of the at least four phases, and to determine an end point of a final preamble when the number of sampling signals generated satisfies a predetermined condition for each phase.

11. A method of decoding data, the method comprising:
removing a subcarrier from first data through a comparison operation being performed on the first data and a first signal corresponding to the subcarrier, to generate second data;
removing noise from the second signal to generate a third signal;
detecting a preamble for the third signal; and
decoding the third signal based on the detected preamble.

12. The method of claim 11, wherein the removing of the noise from the second signal to generate the third signal further comprises:
conducting a count for the third signal based on an enable signal generated in association with Miller demodulation;
comparing a first count signal to a second count signal during each bit period, the first count signal being used to detect a high value of the third signal for a duration in which a value of the enable signal is ‘0’, and the second count signal being used to detect a high value of the third signal for a duration in which a value of the enable signal is ‘1’; and
generating a decoding bit for a difference between the first count signal and the second count signal based on a predetermined threshold value.

13. The method of claim 12, wherein the enable signal is used to execute synchronization based on an edge of the first data.

14. The method of claim 11, wherein the detecting of the preamble for the third signal comprises:
setting at least four phases of the third signal based on the sampling signal generated for the third signal; and
counting a number of sampling signals generated for each of the at least four phases, and determining an end point of a final preamble when the number of sampling signals generated satisfies a predetermined condition for each phase.
